(19) United States
(12) Patent Application Publication
(10) Pub. No.: US 2019/0158628 A1
(43) Pub. Date: May 23, 2019

(54) Universal self-learning softsensor and its built platform that applies machine learning and advanced analytics

(71) Applicant: JIANZHONG FU, COVINGTON, VA (US)

(72) Inventor: JIANZHONG FU, COVINGTON, VA (US)

(21) Appl. No.: 16/184,351

(22) Filed: Nov. 8, 2018

Related U.S. Application Data
(60) Provisional application No. 62/583,577, filed on Nov. 9, 2017.

(51) Int. Cl. H04L 29/08; G06N 20/00; H04W 4/38

(52) U.S. Cl. CPC H04L 67/34; H04L 67/02; H04W 4/38; G06N 20/00

(57) ABSTRACT

A universal self-learning softsensor is built on a cloud computing platform applying machine learning and advanced analytics. The softsensor accumulates data and self-learns the relationship between a target and its inputs, and delivers optimized results to Internet, mobile device, or user-designated locations. The cloud platform applies pre-configured or newly-developed machine learning and advanced analytics applications from fee-licensed and or open-source free-licensed third parties and delivers the best results optimized from these applications.

### CROSS-REFERENCE TO RELATED APPLICATION

This application claims the benefit of U.S. Provisional Application No. 62/583,577, filed on Nov. 9, 2017, entitled “A cloud computing platform in applying advanced machine learning and bigdata analytics”.

### BACKGROUND OF THE INVENTION

### 1. Field of the Invention

The present invention generally relates to use machine learning and advanced analytics to build predictive models. More particularly, the present invention relates to a universal self-learning softsensor and its built platform.

### 2. Description of the Related Art

Machine learning and advanced analytics, such as Artificial Neural Network (ANN) and Classification and Regression Tree (CART), have found many applications in building predictive models from data [1-3]. These advanced analytics, available in a variety software packages from open-source or fee-licensed third parties, typically require lots of computing power and interactive known-how user's inputs; meanwhile, skills in programming and knowledge in a specific industrial process are often necessary in order to use these such advanced analytics in solving real world problems. A softsensor is typically a predictive model that estimates the value of a process property. There are several patented softsensors developed for some specified process properties and controls [4-5] or improvements [6-7], none of them can self-learn and apply to universal cases.

### SUMMARY OF THE INVENTION

A cloud computing platform, in one embodiment, comprises at least one browser based or mobile APP based interface or customized data collector, at least one cloud storage, and at least one cloud computing unit. The interface allows a user or multiple users to configure or select subscribed services of machine learning and advanced analytics and upload their data to the cloud storage in queue for process. User's historian or real-time data can also be customized through a data collector to automatically feed to the cloud storage in queue for process. The cloud storage transfers users' data to the computing unit and optimized results back to user from the computing unit. The computing unit applies a set of machine learning and advanced analytics tools, which may include Artificial Neural Network (ANN), Classification and Regression Trees (CART), Partial Least Squares (PLS), Principal Components Analysis (PCA), and any other pre-configured or newly-developed applications from fee-licensed and or open-source free-licensed third parties available in market. The computing unit processes user's data through the selected tools and delivers the best results back to the user.

A universal softsensor built on the said platform, in one embodiment, comprises at least one browser based or mobile APP based interface or customized data collector, at least one cloud storage, and at least one cloud computing unit. A user can upload its historian or real-time data through the interface or data collector to the softsensor, which then accumulates user's data and self-learns the relationship between one or more targets and its or their inputs, and delivers optimized results generated from the said computing unit to Internet, mobile device, or user-designated locations. It can be used to measure or test a target from at least one variable for manufacturing processes or predict an output from inputs for any processes that have valid observations.

The uniqueness of the present invention is that it does not require its user to have any programming skills, and it can apply to universal cases, self-learning, and deliver outputs to user designated locations, such as a mobile device, and more, it applies and optimizes well-known machine learning and advanced analytics applications in market and delivers the best results. While particular embodiments in accordance with the disclosure have been specifically described within this Summary, it is noted that the disclosure and the claimed subject matter are not limited in any way by these embodiments, by the aforementioned machine learning and advanced analytics, by specific third parties, by browser based or mobile APP based interface or by customized data collector, and or by industrial process data.

### BRIEF DESCRIPTION OF THE DRAWINGS

The concepts described herein are illustrated by way of example and not by way of limitation in the accompanying figures.

FIG. 1 is a simplified block diagram of at least one embodiment of a cloud computing platform.

FIG. 2 is a simplified block diagram of at least one embodiment of various interfaces that may be established at the platform of FIG. 1 for ordering integrated analytics, configuring the selected analytics, and displaying the results of selected analytics.

### DETAILED DESCRIPTION OF THE INVENTION

Embodiments presented herein provide a softsensor and its built platform to demonstrate the features of self-learning and identifying insights from data. More specifically, embodiments presented herein can self-learn a relationship between the temperature conversion function of Fahrenheit to Celsius, and the platform can allow users to leverage process knowledge and diagnose massive industrial process data for process improvement without programming skills.

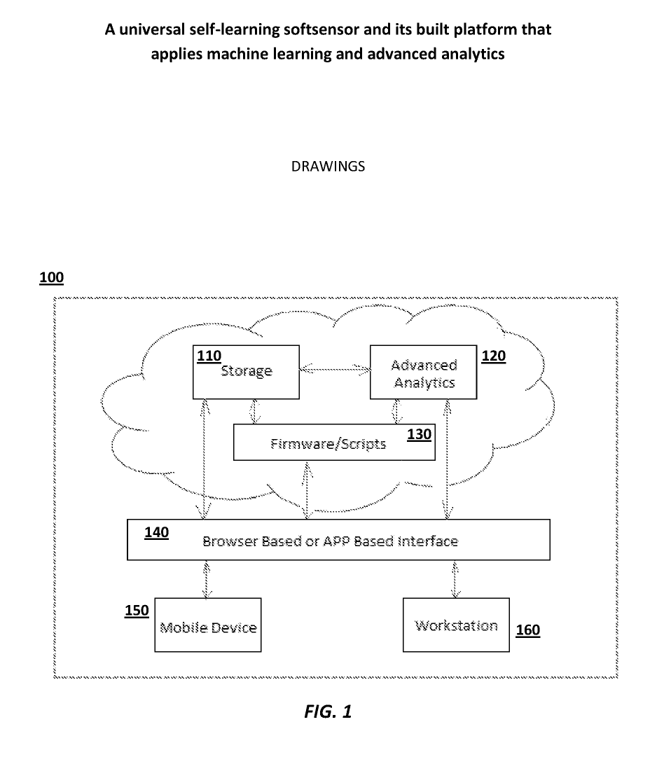

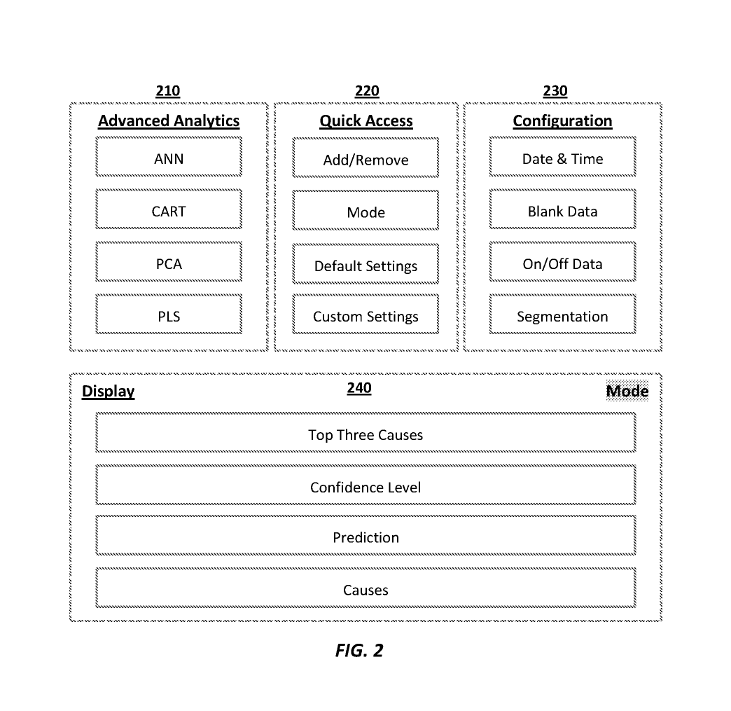

In one embodiment, as shown in FIG. 1, the cloud analyzing platform 100 is constructed to have a Storage 110, a cloud computing unit 120 integrated with pre-configured and or newly-developed Machine Learning and Advanced Analytics, both 110 and 120 are controlled through apps or Firmware/Scripts 130. The platform provides a Browser Based or APP Based Interface 140 that is accessible from users' Mobile Device 150 and Workstation 160 to communicate with the Storage 110 and the Advanced Analytics 120 at the computing unit. The Browser Based or Mobile APP Based Interface 140 is designed to allow users to load their data and receive outputs. A test was performed with a 1200 observations of Fahrenheit-to-Celsius conversion, shorted as F2C; the F2C dataset is structured as—the first 1000 lines with actual values of the target, from which the embodiment (softsensor) can learn, and the last 200 lines with the actual values being replaced by randomly generated values, used to validate the predicted outputs after completed the learning and replaced back the actual target values. Upon uploaded the F2C dataset to the softsensor through the Interface 140, the dataset are mixed with other 98 preloaded independent variables to form a 100 variables base, which may include Logarithms, Periodic, Power, Polynomial functions, etc., and or randomly generated datasets. Basically, the Fahrenheit-to-Celsius relationship is hidden in 6.33825E+29 possible relationships, sum of C(99,1)+C(99,2)+C(99,3)+ . . . +C(99,98)+C(99,99), assuming the order of variables does not matter, i.e., f(x1, x2) is the same as f(x2, x1). The softsensor is pre-configured to ensure it at least learned once of the entire data set. Its learn performance can be simply evaluated by absolute percentage change of from target to predict (PCT_err) and the counts of PCT_err <20 among the latest 100 predicts (Err20PCT100), and R Square from the latest 100 predicts (R_Square 100). Note PCT_err may be huge when target is near zero; in real world cases, whether or not it is acceptable should be also evaluated by its absolute error and target range, or other indicators, such as Root-Mean-Square Error (RMSE), and specific process requirements. The said embodiment self-learned the relationship of Fahrenheit-to-Celsius conversion and reached average PCT_err of ^{˜}10%, 88% of latest 100 predicts having PCT_Err less than 20%, and R square near 1, compared with the first run (before learning) of average PCT_err of 1500%, 4% of latest 100 predicts have PCT_Err less than 20%, and R square near 0. In one embodiment, as shown in FIG. 1, the cloud analyzing platform 100 is constructed to have a Storage 110, a cloud computing unit 120 integrated with Advanced Analytics, both 110 and 120 are controlled through Firmware/Scripts 130. The platform provides a Browser Based or APP Based Interface 140 that is accessible from users' Mobile Device 150 and Workstation 160 to communicate with the Storage 110 and the Advanced Analytics 120 at the computing unit. The Browser Based or APP Based Interface 140 is designed to include a Block 210 for listing advanced analytics, a Block 220 to quick access available tools, a Block 230 for users to customize, and a Block 240 to display the findings, as shown in FIG. 2.

When applying advanced machine learning and bigdata analytics, for example ANN and CART etc., users typically analyze their data in a stand-alone workstation or server and must have certain level of programing skills to effectively take advantages of such analytics from various open-source or fee-licensed third parties.

In one embodiment, the integrated advanced analytics of the computing unit 120 can be linked to the Advanced Analytics Block 210 shown as a Button of “ANN”, a Button of “CART”, a Button of “PCA” and a Button of “PLS”, etc., as shown in FIG. 2, allowing users to apply these analytics without programming skills. When any of these buttons is clicked, a corresponding analytics application will be ordered from the computing unit 120 and a set of configuration tools will be listed at the Configuration Block 230, customizable in different Modes as listed in the Quick Access Block 220. The listed analytics can be selected through the Button of “Add/Remove” in the Quick Access Block 220.

The Quick Access Block 220 has a Button of “Add/Remove”, a Button of “Mode”, a Button of “Default Settings” and a Button of “Custom Settings”, as shown in FIG. 2. The Button of “Add/Remove” can add or remove listed Advanced Analytics at the Block 210 and the set of tools listed at the Configuration Block 230; the listed setup tools can be preconfigured and are associated with a specific analytics. The Button of “Mode” can set as: 1) Automatic Mode, available after each phase of an analytic approach has been preconfigured; 2) Manual Mode, which allows users to upload data and configure settings for data cleaning and processing as well as validating findings; 3) Vendor Comparison Mode, configurable when the same analytics is integrated with several common vendors' software packages; and 4) Model Comparison Mode, which allows users to find best model suitable to their targets. The Button of “Default Settings” allows users to load saved history settings. The Button of “Custom Settings” allows users to configure preferred settings or modify a history setting to meet the desired analysis goals, especially for setting up Automatic Mode.

Data preparation, including data cleaning, processing, and alignment, typically takes more than 90% of the time users used for troubleshooting their process issues; it was a painful and a must effort for many scientists and process engineers, who rarely have such luxury time while fire-fighting their process issues.

In one embodiment, several basic data preparation tools can be linked to the Configuration Block 230, shown as a Button of “Date & Time”, a Button of “Blank Data”, a Button of “On/Off Data” and a Button of “Segmentation”, etc., as shown in FIG. 2, allowing users to apply these tools to pretreat their data. For example, the “Date & Time” Button allows users to set proper date and time format that are suit to their applications, and can be properly aligned; the “Blank Data” Button allows users to configure what value should be applied to their data, such as zero, previous or interpolated values; the “On/Off Data” Button allows users to digitalize the data according to their needs, and the “Segmentation” Button allows users to leverage their process knowledge to classify their data.

Visualization of the results, searching and diagnosing findings, and predicted values and related solutions can be displayed at the Browser Based or APP Based Interface 140 and users' designated locations or mobile devices. The displaying contents can be associated with user selected modes from the Quick Access Block 220.

In one embodiment, the Display Block 240 as shown in FIG. 2, under a selected mode, is configured to list Top Three Causes for users' target; predicted values in either run chart or table format; each value is associated with a confidence level that can help users make timely and data-based decisions; and all identified Causes can be listed according user configured criteria.

While the foregoing is directed to embodiments of the present disclosure, other and further embodiments of the disclosure may be devised without departing from the basic scope thereof, and the scope thereof is determined by the claims that follow.

What is claimed is:

1. A cloud platform that users can subscribe machine learning and advanced analytics applications that are applied on a cloud computing unit and upload their data to cloud storage in queue for process through a browser based or mobile APP based interface or customized data collector.

2. The applied machine learning and advanced analytics of claim 1 includes pre-configured and or newly-developed applications from fee-licensed and or open-source free-licensed third parties and delivers the best results from these applications that process the same user data.

3. The browser based or mobile APP based interface or customized data collector of claim 1, wherein the interface or data collector is presented to Internet or a private or hybrid networks.

4. The cloud computing unit of claim 1, wherein the computing unit comprises at least one physical or virtual computer workstation or server maintained at Internet or private or hybrid networks.

5. The cloud storage of claim 1, wherein the storage is a physical or virtual computer workstation or server maintained at Internet or private or hybrid networks.

6. A universal self-learning softsensor built on the said platform. The softsensor can self-learn the relationship between one or more targets and its or their inputs, and delivers optimized results generated from the said computing unit to Internet, mobile device, or user-designated locations.
